(19) United States
(12) Patent Application Publication
(10) Pub. No.: US 2025/0347858 A1
(43) Pub. Date: Nov. 13, 2025

(54) Optical Ferrule and Optical Plug Connector Having an Optical Ferrule

(71) Applicant: ROSENBERGER HOCHFREQUENZTECHNIK GMBH & CO. KG, Fridolfing (DE)

(72) Inventors: Andreas Fischer, Eiselfing (DE); Stefan Schmidt, Waging am See (DE); Thomas Maier, Burghausen (DE); Till Bredbeck, Siegsdorf (DE)

(21) Appl. No.: 19/202,279

(22) Filed: May 8, 2025

(30) Foreign Application Priority Data
May 10, 2024 (EP) 24175125.4

(51) Int. Cl. G02B 6/38

(52) U.S. Cl. CPC G02B 6/3881; G02B 6/3853; G02B 6/3893

(57) ABSTRACT

Optical ferrule includes a fixing area for fixing an axial end section of the optical waveguide. The fixing area is designed such that a longitudinal axis of the axial end section of the optical waveguide is alignable in a plug-in direction S of the optical ferrule. The optical ferrule further includes an optical area for beamforming between a light beam bundle transmitted in the optical waveguide and the light beam bundle transmitted in a focused or collimated manner in a free space. The optical area axially adjoins the fixing area in the plug-in direction S and a beamforming means having an optical axis extending in the plug-in direction S is formed therein. The optical ferrule further includes at least one guide area having a longitudinal extension in the plug-in direction S, which has a plurality of grooved segments.

### AREA OF THE INVENTION

The present invention relates to an optical ferrule for fixing and aligning an optical waveguide with a counter optical waveguide of an optical counter ferrule.

The present invention additionally relates to an optical plug connector, which has an optical ferrule in a plug connector housing.

Finally, the present invention also relates to an optical plug connection made up of an optical plug connector and an associated optical counter plug connector.

### TECHNICAL BACKGROUND

Electrical connection technology is still widespread for transmitting data between various assemblies in automobiles. However, optical transmission technology is less sensitive to electromagnetic interference than electrical connection technology. In addition, an optical data network enables a data transmission at a higher bandwidth and is linked to a lower cabling weight and therefore lower cabling costs.

Up to this point, plastic light guides have been used in optical data networks in automotive engineering. Fiber optic light guides enable a higher bandwidth in the data transmission than plastic light guides and a use in a higher temperature range and are therefore of great interest for high-speed data transfer in future automobile generations. While the core diameter of a plastic light guide is approximately 1 mm in size, the core diameter of a fiber optic light guides is significantly smaller and is approximately 50 μm for a multimode transmission and approximately 10 μm for a monomode transmission.

Therefore, significantly higher demands are placed on the alignment of fiber optic light guides to be coupled in an optical plug connection than in the case of the coupling of plastic light guides.

This is a state which should be improved.

### DESCRIPTION OF THE INVENTION

Against this background, the present invention is based on the object of specifying a technical solution for an alignment of optical waveguides to be coupled in an optical connection, in particular in an optical plug connection, with a high degree of exactness.

This object is achieved according to the invention by an optical ferrule having the features disclosed herein.

The following is accordingly provided:

An optical ferrule aligning an optical waveguide, preferably an optical fiber, with a counter optical waveguide, preferably an optical counter fiber, of an optical counter ferrule, having
a fixing area for fixing an axial end section of the optical waveguide, wherein the fixing area is designed such that a longitudinal axis of the axial end section of the optical waveguide is alignable in a plug-in direction of the optical ferrule,
an optical area for beamforming between a light beam bundle transmitted in the optical waveguide and the light beam bundle transmitted in a focused or collimated manner in a free space, which axially adjoins the fixing area in the plug-in direction, and
in which a beamforming means, preferably a converging lens, having an optical axis extending in the plug-in direction is formed for the optical waveguide, and
at least one guide area having a longitudinal extension in the plug-in direction, which in each case has a grooved segment,
wherein the grooved segments are each formed laterally adjacent to the beamforming means and
are each configured to align themselves with a ribbed segment of an associated counter guide area of the optical counter ferrule.

The finding/concept underlying the present invention is to implement an optical coupling between individual optical glass fibers of an optical plug connector and the associated optical glass fibers of an optical counter plug connector in which the light beam bundle emitted from each of the individual optical glass fibers is formed in a focused or collimated manner in the plug-in direction of the optical plug connection and the focused or collimated formed light beam bundle of each optical glass fiber is fed without an offset and therefore without an optical loss into the associated optical glass fiber of the optical counter plug connector.

For this purpose, an optical ferrule according to the invention is provided, in which the three following technical measures are implemented:
1) a fixing area of the optical ferrule, in which each optical fiber is aligned in its axial end area in the plug-in direction of the optical ferrule, i.e. in the longitudinal axial direction of the optical ferrule, and therefore a light beam bundle is emitted at a fiber end face of the optical fiber in a light cone having an axis of symmetry in the plug-in direction,
2) an optical area of the optical ferrule, which axially adjoins the fixing area in the plug-in direction and has a beamforming means, preferably a converging lens, for each optical fiber; in the beamforming means, the light beam bundle of the optical waveguide emitted in a light cone is emitted in a light beam bundle formed in a focused or collimated manner in the plug-in direction having an optical axis in the plug-in direction in a free space axially adjoining the optical area or a light beam bundle formed in a focused or collimated manner having an optical axis in the plug-in direction is received from the free space and coupled into the optical waveguide, and
3) at least one guide area of the optical ferrule, in each of which a grooved segment is formed for guiding a ribbed segment of an optical counter ferrule.

With the last-mentioned technical measure of at least one guide area, a linear guide between the optical ferrule and the optical counter ferrule is implemented in each case in the plug-in direction, so that in the plugged-in state of the optical ferrule and the optical counter ferrule, the longitudinal axis of the optical ferrule comes to rest on the longitudinal axis of the optical counter ferrule. The optical axes of the beamforming means of the optical ferrule and the optical counter ferrule, which are associated with one another, come into congruence when the optical axes of the beamforming means are each directed parallel the to longitudinal axis of the optical ferrule or the optical counter ferrule and are each formed in an identical lateral location in relation to the longitudinal axis of the optical ferrule or the optical counter ferrule.

It is therefore ensured that in the case of a unidirectional optical transmission, the focused or collimated light beam bundle of the individual beamforming means of the optical ferrule is incident completely in each case on the associated beamforming means of the optical counter ferrule and is coupled into the counter ferrule at the fiber end face of the associated optical fiber. It is equivalently ensured in the case of a bidirectional optical transmission that the light beam bundle emitted in a focused or collimated manner by the individual beamforming means of the optical ferrule or the optical counter ferrule is incident on the associated beamforming means of the optical counter ferrule or the optical ferrule. In both cases, a reduction of the signal damping or insertion damping and an increase of the backflow damping of the optical transmission is advantageously achieved.

Due to the at least one linear guide between the optical ferrule and the optical counter ferrule, the optical ferrule is aligned in each case to the counter ferrule in two translational dimensions, i.e. in a first transverse direction which is oriented orthogonally to the longitudinal axial direction and therefore to the plug-in direction, and in a second transverse direction, which is oriented orthogonally to the longitudinal axial direction (or to the plug-in direction) and to the first transverse direction. In addition, the optical ferrule is aligned in three rotational dimensions in relation to the counter ferrule by the at least one linear guide between the optical ferrule and the optical counter ferrule and therefore cannot rotate or tilt in each case relative to the longitudinal axis and to two transverse axes of the optical ferrule. The at least one linear guide offers freedom of movement only in the longitudinal axial direction (or in the plug-in direction) of the optical ferrule in each case, which is not absolutely necessary, however, in the case of a light beam bundle transmitted in a focused or collimated manner in the longitudinal axial direction between the beamforming means of the optical ferrule and the optical counter ferrule.

Such a linear guide not only implements an alignment between the optical ferrule and the associated optical counter ferrule during the plug-in procedure, but also enables the ribbed segment of the associated counter guide area of the optical counter ferrule to be accommodated in the grooved segment of each guide area of the optical ferrule in the plugged-in state.

Such a design advantageously prevents an axial offset between the optical ferrule and the associated optical counter ferrule. In addition, such a design lacks sensitivity to contaminants in the area between the beamforming means of the optical ferrule and the associated optical counter ferrule. The diameter of the parallel light beams in the area between two opposing beamforming means is expanded in relation to the diameter of the light beams in the optical waveguide (“expanded beam”). The interfering influence of a dirt particle is accordingly reduced in the case of an expanded light beam bundle in relation to a non-expanded light beam bundle.

An optical ferrule is understood in this case and hereinafter as a component which in each case accommodates and fixes an axial end area of individual optical waveguides and, in a plug-in procedure with an associated optical counter ferrule, aligns the individual optical waveguide relative to an associated counter optical waveguide of the optical counter ferrule.

The optical ferrule can be produced from an optically transparent material, preferably from an optically transparent plastic or alternatively from an optically transparent glass or from an optically transparent inorganic material. In particular, a thermoplastic and very particularly polyether imide (PEI) is suitable for this purpose. In addition, polycarbonate (PC) or polystyrene (PS) is usable as an alternative thermoplastic, however. The three mentioned thermoplastics are each light-transmissive and therefore transparent in the spectral range of visible light and in the preferably used spectral range of infrared light, which is typically used in each case for the transmission of the light in the individual waveguides, in the optical plug connection, in the optical ferrule, and the associated optical counter ferrule. In addition, the three mentioned thermoplastics are distinguished by simple and high-precision producibility in a plastic injection molding process.

The optical ferrule is preferably integrally formed. In a less preferred design, the optical ferrule can also be formed in multiple parts and these can be connectable to one another by suitable precision connection technologies. The optical ferrule preferably has an essentially cuboid basic geometry.

The optical ferrule can be coated with an antireflective coating at least in the area of the optically active surfaces of the beamforming means or alternatively over the entire surface.

The optical waveguide is preferably formed as an optical fiber and in particular as a fiber made of quartz glass, a so-called optical glass fiber. Both grade index fibers and gradient index fibers are possible as optical fibers. The optical fibers can transmit both multiple modes (so-called multimode fibers) and also only one single fundamental mode (so-called monomode fibers).

The optical ferrule can accommodate at least one optical waveguide and align it to an optical waveguide of an associated counter ferrule. For a bidirectional optical transmission, in particular in automotive engineering, preferably two optical waveguides, 4 optical waveguides, 8 optical waveguides, 12 optical waveguides, 16 optical waveguides, or 2·n optical waveguides can be accommodated in an optical ferrule (n is a positive integer in this case). For special applications, an odd number of optical waveguides can also be accommodated in the optical ferrule, however.

The at least one optical waveguide is fastened in a fixing area of the optical ferrule and aligned in each case by the fastening in the direction of the longitudinal axis (or the plug-in direction) of the optical ferrule. In the case of multiple optical waveguides, the individual optical waveguides are fixed adjacent to one another in a first transverse direction or first transverse axial direction oriented orthogonally to the longitudinal axial direction (or plug-in direction) and are each aligned parallel to the longitudinal axial direction (or plug-in direction). To align the optical axes of optical waveguides associated with one another (and of beamforming means associated with one another) of the optical ferrule and the optical counter ferrule in relation to one another, the optical waveguides in the fixing area and the beamforming means in the optical area can each preferably be arranged symmetrically to the longitudinal axis of the optical ferrule or the optical counter ferrule. An increase of the optical waveguides to be connected can be implemented by an arrangement of the optical waveguides in both second transverse directions (on the “upper side” and on the “lower side” of the optical ferrule). A further increase of the optical waveguides can be implemented by an arrangement of the optical waveguides in multiple rows or levels in both second transverse directions, preferably in two rows or two levels. For easier assembly, the optical waveguides can preferably each be arranged laterally offset in the individual rows or levels.

The individual optical waveguide is inserted in each case within the fixing area into an associated groove of the fixing area, which is formed in each case in the longitudinal axial direction of the optical ferrule on a lateral surface of the essentially cuboid optical ferrule. The optical waveguide is preferably aligned in an axial direction on the groove such that the fiber end face of the optical waveguide contacts the optical ferrule at the axial end of the groove. In a less preferred embodiment, the fiber end face of the optical waveguide can also be spaced apart slightly from the axial end of the groove.

The cross-sectional profile of the groove is preferably formed V-shaped or alternatively U-shaped, so that the optical waveguide locates itself in a self-joining and self-aligning manner in the center of the groove and is therefore aligned centrally in relation to the groove in a transverse direction of the optical ferrule or groove. The inner core of the optical waveguide is typically exposed of the casing, of the protective coating, and of the outer shell in an axial end section of the optical waveguide. Within the groove, preferably only the exposed inner core of the optical waveguide is inserted. The optical waveguide preferably stops on the cable-side end of the groove with the casing, the protective coating, and the outer shell.

The fixing of the optical waveguide in the associated groove of the fixing area preferably takes place by means of adhesive bonding using a thermally curable adhesive, for example using an adhesive made of epoxy resin and a curing agent, or using a two-component adhesive, which is curable under the effect of a UV light beam. The adhesive is preferably designed as light-transmissive and therefore transparent in the spectral range of visible light and in the preferably used spectral range of infrared light. The adhesive preferably surrounds the entire circumference of the optical waveguide over the longitudinal extension of the groove and therefore enables fixing of the optical waveguide on the groove over the longitudinal extension of the groove. In this way, refraction of the core of the optical waveguide in the event of vibration- related tensions and pressures between the optical ferrule and the individual optical waveguides is prevented. To prevent undesired refraction of the light emitted at the fiber end face of the optical waveguide in the transition between the adhesive and the optical ferrule in the case of a fiber end face of the optical waveguide spaced apart from the optical ferrule, the index of refraction of the adhesive is preferably matched to the index of refraction of the optical ferrule.

In the plug-in direction of the optical ferrule, the optical area of the optical ferrule preferably directly adjoins the fixing area. According to the number of grooves formed in the fixing area for the purpose of fixing an optical waveguide in each case, a corresponding number of optical channels is formed in an associated manner in the optical area. A beamforming means is assigned to each optical channel, and expands the light emitted by the optical waveguide from the input-side optically active surface of the beamforming means in the plug-in direction up to the output-side optically active surface of the beamforming means in the plug-in direction and emits a light beam bundle which is expanded and focused or collimated in the longitudinal axial direction (or in the plug-in direction) at the output-side optically active surface. The beamforming means formed in the optical area in each case is preferably designed as a converging lens and is preferably implemented integrally with the remaining body of the optical ferrule. An associated section is therefore assigned for each converging lens in the optical area of the optical ferrule, and extends from an associated input-side optically active surface to an associated output-side optically active surface. The associated input-side optical surface of the converging lens implemented in each case in the optical area forms the front face at the axial end of the groove in the fixing area associated with the respective converging lens. The associated output-side optical surface of the converging lens implemented in each case in the optical area forms the front face area formed in each case in the plug-in direction at the axial end of the optical area.

The individual converging lens, which can also be referred to as a positive lens, is preferably formed as a plano-convex converging lens. The input-side optically active surface is therefore formed planar and the output-side optically active surface is convexly curved. In a further embodiment, the individual converging lens can also be formed as a concave-convex converging lens. In this case, the input-side optically active surface is concavely curved and the output-side optically active surface is convexly curved.

The index of refraction of the optical ferrule and the radius of curvature of the individual output-side optically active surfaces of the sections of the optical area each associated with the individual converging lenses are preferably formed such that the focal length of the individual converging lenses comes to rest in each case in the fiber end face of the respective optical waveguide. However, it is also conceivable that due to a suitable alternative parameterization of the index of refraction and the radius of curvature, the focal length comes to rest slightly spaced apart from the fiber end face either within the respective optical waveguide or in the associated section of the optical area belonging to the respective converging lens.

For optimized beam guiding in the optical area of the optical ferrule, the individual convexly formed optically active surfaces can preferably each be formed aspheric, i.e. with a curvature deviating from the curvature of a spherical surface, on the output-side end of the optical area in the plug-in direction.

The plug-in direction of the optical ferrule essentially takes place in the longitudinal axial direction of the optical ferrule. The plug-in direction of the optical counter ferrule, which is accordingly essentially directed in the longitudinal axial direction of the optical counter ferrule, is therefore in the ideal case directed opposite to the plug-in direction of the optical ferrule. In the real case, a rotational offset between the optical ferrule and the optical counter ferrule in the three rotational degrees of freedom and a translational offset between the longitudinal axis of the optical ferrule and the optical counter ferrule in the three translational degrees of freedom can only occur to a minimal extent.

To align the longitudinal axis of the optical ferrule and the optical counter ferrule in the plug-in procedure, a linear guide is formed between the optical ferrule and the optical counter ferrule. To form a linear guide with the optical counter ferrule, at least one guide area is provided in the optical ferrule, which has a grooved segment in each case.

The grooved segment of the optical ferrule is configured to align itself on a corresponding ribbed segment of an associated counter guide area of the optical counter ferrule.

In one preferred first embodiment of the optical ferrule, two guide areas can be provided, between which the optical area having all beamforming means formed therein is located. The two guide areas are each formed in this case laterally adjacent to the optical area in a first transverse direction. The longitudinal axial direction (or plug-in direction), the first transverse direction, and the second transverse direction are extension directions of the optical ferrule each oriented orthogonally to one another. The second transverse direction is in this case the direction of the surface vector which is associated with the planar first guide surface of each individual guide area to be explained hereinafter. The two guide areas immediately and directly laterally adjoin the optical area. In particular, a side wall of the grooved segment associated with each of the two guide areas can be formed by a side wall of the optical area in each case. In addition, the two guide areas can also be formed laterally adjacent to the fixing area and to the receptacle area still to be explained.

In an alternative second embodiment of the optical ferrule, a single guide area can be provided, which is located centrally along the longitudinal axis of the optical ferrule between two sections of the optical area. The grooved segment of the single guide area is formed immediately and directly laterally between the two sections of the optical area. In particular, the two side walls of the grooved segment of the single guide area can be formed in each case by one side wall of the two sections of the optical area. The beamforming means formed in each case in the optical area are formed distributed onto the two sections of the optical area, in particular distributed equally. In addition, the single guide area can also be formed laterally adjacent to the fixing area and to the receptacle area still to be explained.

In an alternative third embodiment of the optical ferrule, a single guide area can be provided which is formed laterally adjacent to the optical area and to the fixing area in the second transverse direction. The single guide area is therefore formed above the optical area and the fixing area. The grooved segment of the single guide area is arranged between two side walls each formed in the first transverse direction of the optical ferrule.

The grooved segment of each guide area and therefore also the ribbed segment of the associated counter guide area each preferably have a rectangular cross-sectional profile. The extension of the rectangular cross-sectional profile is embodied as constant in a preferred design in each case along the longitudinal extension of the grooved segment of each guide area and therefore the ribbed segment of the associated counter guide area.

In a further design, the distance between the two side walls of the rectangular cross-sectional profile of the grooved segment of the guide area of the optical ferrule can taper in a direction opposite to the plug-in direction of the optical ferrule. Correspondingly, the distance between the two side walls of the rectangular cross-sectional profile of the ribbed segment of the associated counter guide area of the optical counter ferrule can taper in a plug-in direction of the optical counter ferrule. The taper can be embodied as stepped, linear, or curved in this case. In addition to the alignment function, a stop function can be implemented along the longitudinal axis of the optical ferrule by such a design.

In the case of a single guide area, the two side walls of the ribbed segment of the counter guide area of the optical counter ferrule are guided in a formfitting manner between the two side walls of the grooved segment of the guide area of the optical ferrule. In the case of two guide areas, the inner side walls or the outer side walls of the ribbed segments of the two counter guide areas of the optical counter ferrule are each guided in a formfitting manner between the outer side walls or the inner side walls of the grooved segments of the two guide areas of the optical ferrule. In both cases, the optical ferrule and the optical counter ferrule are each aligned in relation to one another in both first transverse directions (positive first transverse direction and negative first transverse direction).

In addition to the two side walls, the grooved segment of each guide area of the optical ferrule has in each case a planar base surface connecting the two side walls. The ribbed segment of each counter guide area of the optical counter ferrule has in each case a cover surface of the ribbed segment connecting the two side walls of the ribbed segment. The base surface of the grooved segment of each guide area of the optical ferrule is guided on the cover surface of the ribbed segment of the associated counter guide area of the optical counter ferrule in a second transverse direction, which is oriented in each case orthogonally to the longitudinal axial direction (or to the plug-in direction) and to the first transverse direction, in the plug-in procedure of the optical ferrule and the optical counter ferrule. The optical ferrule and the optical counter ferrule are therefore also aligned in relation to one another in the second transverse direction.

In that each guide area, in particular the grooved segment of each guide area, of the optical ferrule and the associated counter guide area, in particular the ribbed segment of the associated counter guide area, of the optical counter ferrule each have a significant longitudinal extension, twisting or tilting of the optical ferrule relative to the optical counter ferrule around an axis in the first transverse direction is prevented in the plugged-together state of the optical ferrule and the optical counter ferrule.

In that the side walls of the at least one guide area of the optical ferrule are aligned on the side walls of the associated counter guide area of the optical counter ferrule in the plugged-together state of the optical ferrule and the optical counter ferrule, lateral twisting or lateral tilting of the optical ferrule in relation to the optical counter ferrule around an axis in the second transverse direction is prevented.

The transverse extension of a single pair made up of guide area and counter guide area and in particular the symmetrical arrangement of two pairs made up of guide area and counter guide area relative to the longitudinal axis of the optical ferrule aligns the optical ferrule and the optical counter ferrule in relation to one another in the plug-in procedure such that in the plugged-together state, the optical counter ferrule has an orientation rotated by 180° to the optical ferrule relative to the longitudinal axis of the optical ferrule. In the plugged-together state, twisting or tilting of the optical ferrule in relation to the optical counter ferrule out of the mentioned ideal location around the longitudinal axis of the optical ferrule or the optical counter ferrule is therefore prevented.

The five mentioned alignment states of the optical ferrule to the optical counter ferrule in the plugged-together state (two translational and three rotational alignment states) make it possible that with the best possible manufacturing accuracy of the optical ferrule or the optical counter ferrule, the light emitted in a focused or collimated manner in each case by the beamforming means of the optical ferrule and by the beamforming means of the optical counter ferrule is incident completely without light loss in each case on the associated beamforming means of the optical counter ferrule or the optical ferrule.

Advantageous embodiments and refinements result from the description with reference to the figures of the drawing.

It is obvious that the features mentioned above and still to be explained hereinafter are usable not only in the respective specified combination, but also in other combinations or alone, without departing from the scope of the present invention.

In a preferred refinement of the optical ferrule according to the invention, the at least one guide area can additionally have in each case a ribbed segment, which axially adjoins the grooved segment in the plug-in direction. The ribbed segment of the individual guide areas is configured to align itself in each case with a grooved segment of the associated counter guide area.

Since the longitudinal extension of the ribbed segment of each guide area corresponds to the longitudinal extension of the grooved segment of each guide area, the longitudinal extension of the optical ferrule is doubled by such a technical measure. The extension of the ferrule enables, with given manufacturing accuracy of the optical ferrule, a reduction of the twisting or tilting between the optical ferrule and the optical counter ferrule relative to the axis in the first transverse direction in the plugged-together state.

The formation of guide areas each having a grooved segment and a ribbed segment axially adjoining in the plug-in direction in the optical ferrule or in the optical counter ferrule advantageously enables the implementation of a mechanical interface of the optical ferrule embodied as hermaphroditic. A mechanical interface of the optical ferrule embodied as hermaphroditic is designed identically to the mechanical counter ferrule embodied as interface of the optical hermaphroditic. A mechanical interface of the optical ferrule embodied as hermaphroditic and a mechanical interface of the optical counter ferrule likewise embodied as hermaphroditic are pluggable together with one another in plug-in directions each directed opposite to one another. The mechanical interfaces of the optical ferrule and the optical counter ferrule embodied as hermaphroditic are oriented in this case rotated in relation to one another by 180° in relation to the common longitudinal axis in the plug-in procedure. If the receptacle area, the fixing area, and the optical areas of the optical ferrule and the optical counter ferrule are additionally each embodied as symmetrical to the respective longitudinal axis, then the optical ferrule and the optical counter ferrule are identically formed. The production costs for an optical plug connection are reduced by such a use of identical parts.

The base surface of the grooved segment and the cover surface of the ribbed segment of each guide area axially adjoining the grooved segment can merge into one another either continuously (first and second embodiment of the optical ferrule) or in a stepped manner (third embodiment of the optical ferrule). The base surface of the grooved segment and the cover surface of the axially adjoining ribbed segment of each guide area of the optical ferrule can therefore each form a planar guide surface, which is referred to in this case and hereinafter as a planar first guide surface. The surface vector of each planar first guide surface is directed in the second transverse direction.

Therefore, in the plug-in procedure, each planar first guide surface of the optical ferrule can be guided on the associated planar first counter guide surface of the optical counter ferrule already from the front axial end and along the entire longitudinal extension of the respective counter guide area and can therefore be aligned in the best possible manner.

The planar first guide surface of each guide area and the optical axis of each beamforming means and/or the axial end sections of each optical waveguide can lie in a first sectional plane of the optical ferrule (first and second embodiment of the optical ferrule). Alternatively, the planar first guide surfaces of the grooved segment and the ribbed segment of each guide area can each lie in a different plane parallel to the first sectional plane (third embodiment of the optical ferrule). For the case that the optical axes of each beamforming means and/or the axial end sections of each optical waveguide each lie in a single plane or a single row, the first sectional plane can be spanned by the optical axes of each beamforming means and/or the axial end sections of each optical waveguide. Alternatively, the optical waveguides can be fixed on the upper side and the lower side of the optical ferrule and therefore the optical axes of each beamforming means and/or the axial end sections of each optical waveguide on the lower side of the optical ferrule can each be arranged symmetrically to the optical axes of each beamforming means and/or the axial end sections of each optical waveguide on the upper side of the optical ferrule. In this case, the first sectional plane can be formed by a plane of symmetry of the optical axes of each beamforming means and/or the axial end sections of each optical waveguide. Since additionally the individual planar first guide surfaces of the optical ferrule slide on the associated planar first counter guide surfaces of the optical counter ferrule, it is therefore ensured that the optical axes of the beamforming means of the optical ferrule and the associated beamforming means of the optical counter ferrule are each aligned in relation to one another.

In the plugged-together state, the first sectional plane of the optical ferrule corresponds to the first sectional plane of the optical counter ferrule, due to which a lossless optical signal transmission between the optical ferrule and the optical counter ferrule is possible.

In the case of two guide areas of the optical ferrule, to increase the mechanical stability, the ribbed segments of the two guide areas can preferably be connected to one another at the respective rib base via a direct connection, in particular via a plate-shaped area filling the entire area between the ribbed segments. However, an embodiment of the optical ferrule in which no direct mechanical connection is provided between the two ribbed segments is also conceivable.

The optical ferrule can preferably have a centering surface, which is referred to in this case and hereinafter as the first centering surface, in a front end section, in the plug-in direction of the optical ferrule, of the planar first guide surface of each ribbed segment. The first centering surface can be formed as a chamfer between the planar first guide surface and the axial end face of the ribbed segment of each guide area of the optical ferrule. A first rough centering is produced by the first centering surface in the plug-in procedure in the first contact between the optical ferrule and the optical counter ferrule. The first rough centering causes, if the distance between the longitudinal axes of the optical ferrule and the optical counter ferrule is too small, the optical ferrule and the optical counter ferrule to be moved away from one another far enough until the ideal distance between the longitudinal axes of the optical ferrule and the optical counter ferrule is achieved in the plugged-together state.

The grooved segment and the ribbed segment of each guide area of the optical ferrule are produced with a manufacturing accuracy such that axial guiding and therefore axial movement is possible between each guide area of the optical ferrule and the associated counter guide area of the optical counter guide area of the optical counter ferrule. The optical ferrule and the optical counter ferrule are thus manufactured accurately enough that the least possible play required for the mutual plug-in movement between the at least one guide area and the associated counter guide area can exist. Fine centering between the optical ferrule and the optical counter ferrule is necessary for the exact alignment of the optical ferrule and the optical counter ferrule in the plugged-together state:

For the fine centering between the optical ferrule and the optical counter ferrule in the second transverse direction, in a further preferred design of the optical ferrule, a first centering support, preferably in each case a single first centering support, can protrude in each case from the planar first guide surface in the grooved segment of each guide area. The first centering support can be formed in each case in a surface area of the grooved segment of the respective guide area which is first reached by the ribbed segment of the associated counter guide area of the optical counter ferrule in the completely plugged-together state. A touch between the single first centering support of the optical ferrule and the opposite planar first counter guide surface of the optical counter ferrule therefore only occurs in the completely plugged-together state and therefore at the end of the plug- in movement between the optical ferrule and the optical counter ferrule. The first centering support of each guide area of the optical ferrule can therefore be located on the same line of section of the optical ferrule directed in the second transverse direction. The first centering support can therefore preferably be formed with a small area in relation to the extension of the associated planar first guide surface and preferably can only have a minor extension in the direction of the surface vector of the associated planar first guide surface.

For the fine centering between the optical ferrule and the optical counter ferrule in the second transverse direction, a positioning accuracy of preferably less than 800 μm can be implementable.

In a preferred refinement of the optical ferrule, each guide area in the grooved segment and in the ribbed segment can each have at least one planar second guide surface, each of which is oriented orthogonally to the associated planar first guide surface. In the case of a single guide area, the two side walls of the grooved segment and the ribbed segment can each be formed as a planar second guide surface. In the case of two guide areas, which can be formed symmetrically to the longitudinal axis, either the outer side wall of the grooved segment and the ribbed segment or alternatively the inner side wall of the grooved segment and the ribbed segment of each guide area can each be formed as a planar second guide surface.

The at least one planar second guide surface of each guide area of the optical ferrule forms an alignment between the optical ferrule and the optical counter ferrule in the first transverse direction with the planar second counter guide surface of the associated counter guide area of the optical counter ferrule in the plug-in procedure.

The at least one planar second guide surface of the grooved segment can in each case preferably extend relative to the associated planar first guide surface in an opposite direction to the at least one planar second guide surface of the ribbed segment in each guide area of the optical ferrule. Therefore, in the plugged-together state, the linear guide pairs made up of the at least one grooved segment of the optical ferrule and the associated ribbed segment of the optical counter ferrule can be arranged on the one side of the first sectional plane, and the linear guide pairs made up of the at least one ribbed segment of the optical ferrule and the associated grooved segment of the optical counter ferrule can be arranged on the other side of the first sectional plane.

In a further preferred design of the optical ferrule, a centering surface, which is referred to in this case and hereinafter as a second centering surface, can be formed in each case in an end section, which is in front in the plug-in direction, of the planar second guide surface of each ribbed segment. The second centering surface can be formed as a chamfer between the planar second guide surface and the axial end face of the ribbed segment of each guide area of the optical ferrule. In the initial contact of the ribbed segment of the at least one guide area of the optical ferrule with a grooved segment of an associated counter guide area of the optical counter ferrule during the plug-in procedure, a rough centering between the optical ferrule and the optical counter ferrule is therefore possible in the two first transverse directions (positive first transverse direction and negative first transverse direction). The second centering surface can preferably be formed as a chamfer on an outer planar second guide surface of the ribbed segment of the single guide area of the optical ferrule. Alternatively or additionally, the second centering surface can also be formed as a chamfer on an inner planar second guide surface of the ribbed segment of the single guide area of the optical ferrule.

In addition, in a further preferred design of the optical ferrule, a centering surface, which is referred to in this case and hereinafter as a third centering surface, can be formed in each case in an end section, which is in front in the plug-in direction, of the planar second guide surface of each grooved segment. During the plug-in procedure of the optical ferrule and the optical counter ferrule, an initial contact between the optical ferrule and the optical counter ferrule occurs between the second centering surfaces formed in each case on the optical ferrule and the associated third centering surfaces formed in each case on the optical counter ferrule. A rough centering therefore occurs between the optical ferrule and the optical counter ferrule in the two first transverse directions due to the sliding of the second centering surfaces and the third centering surfaces on one another during the plug-in procedure.

The third centering surfaces can preferably each be formed as a chamfer on an outer planar second guide surface of the grooved segment of a guide area of the optical ferrule. In the case of a single guide area, the two third centering surfaces can each be formed as a chamfer between an end section, which is in front in the plug-in direction, of a planar second guide surface of the grooved segment of the single guide area and the end face of the adjoining section of the optical area or a laterally adjoining side wall. In the case of two guide areas, the two third centering surfaces can each be formed as a chamfer between an end section, which is in front in the plug-in direction, of a planar second guide surface of the grooved segment of a guide area and the end face of a side wall laterally adjoining the respective guide area.

Analogously to the second centering surfaces, the third centering surfaces can also each alternatively or additionally be embodied as a chamfer on inner planar second guide surfaces of the at least one guide area of the optical ferrule.

For the fine alignment between the optical ferrule and the optical counter ferrule in the two first transverse directions, a centering support, which is referred to in this case and hereinafter as a second centering support, can in each case preferably protrude out of each planar second guide surface in the grooved segment of each guide area.

Equivalently to the first centering support, the second centering support can be formed in each case in a surface area of the grooved segment of the respective guide area which is first reached by the ribbed segment of the associated counter guide area of the optical counter ferrule in the completely plugged-together state. A touch between the single second centering support of the optical ferrule and the opposite planar second counter guide surface of the optical counter ferrule therefore first occurs in the completely plugged-together state. Preferably, only one single second centering support can be formed on each planar second guide surface.

The second centering support of each guide area of the optical ferrule can therefore be located on the same line of section of the optical ferrule directed in the first transverse direction. In particular, the first centering support and the second centering support can preferably lie on a common second sectional plane of the optical ferrule. The second sectional plane of the optical ferrule is oriented orthogonally to the first sectional plane of the optical ferrule in this case. The statements made above on the first centering surface apply analogously with respect to the extension of the second centering support. Alternatively, a part of the first or the second centering surfaces of the optical ferrule can also not be formed on the second sectional plane, in particular in an axial section of the optical ferrule upstream from the second sectional plane in the plug-in direction.

In a further preferred embodiment of the optical ferrule, at least one centering means can be formed in the optical ferrule in the first transverse direction laterally adjacent to each beamforming means or to each guide area. A centering means can in each case preferably be formed in the optical ferrule in each of the two first transverse directions in each case directly at the two guide areas or alternatively directly at the optical area in the case of a single guide area. In a less preferred embodiment of a centering, a single centering means can also be formed centrally in relation to the longitudinal axis between two sections of the optical area.

At least one further centering surface can be formed in each case in the single centering means, which has in each case a first directional component in the plug-in direction and a second directional component in a direction opposite to a surface vector of the planar first guide surface.

The single centering means of the optical ferrule cooperates with an associated counter centering means of the optical counter ferrule such that in the plug-in procedure, each centering surface of the single centering means of the optical ferrule slides along at least one counter centering surface of an associated counter centering means of the optical counter ferrule. In this case, the distance between the optical ferrule and the optical counter ferrule is increasingly reduced in the second transverse direction until, in the plugged-together state, each planar first guide surface of the optical ferrule is aligned on the associated planar first counter guide surface of the optical counter ferrule. In the plugged-together state, the single centering means additionally form a stop function in the plug-in direction in cooperation with the associated counter centering means.

Preferably, two centering surfaces are formed in each case on the single centering means, wherein the centering surface formed axially upstream in the plug-in direction is referred to in this case and hereinafter as the fourth centering surface and the centering surface formed axially downstream in the plug-in direction is referred to in this case and hereinafter as the fifth centering surface. Consequently, preferably two counter centering surfaces are formed in each case on the single counter centering means, wherein the counter centering surface axially upstream in the counter plug-in direction is referred to in this case and hereinafter as the fourth counter centering surface and the counter centering surface axially downstream in the counter plug-in direction is referred to in this case and hereinafter as the fifth counter centering surface.

The sliding of the fourth centering surface of each centering means on the fourth counter centering surface of the associated counter centering means causes a rough centering between the optical ferrule and the optical counter ferrule in the second transverse direction. The fine centering between the optical ferrule and the optical counter ferrule in the second transverse direction finally takes place due to the sliding of the fifth centering surface of each centering means on the fifth counter centering surface of the associated counter centering means. For the rough centering, an angle between the surface vector of the fourth centering surface and the plug-in direction can preferably be between 50° and 70° and ideally at 60°. For the fine centering, an angle between the surface vector of the fifth centering surface and the plug-in direction can ideally be at 45° with regard to an optimum force deflection between the plug-in force to be introduced for the plug-in procedure in the plug-in direction and the alignment force in the second transverse direction. If self-inhibiting is utilized between the fifth centering surfaces and the associated fifth counter centering surfaces, then an angle between the surface vector of the fifth centering surface and the plug-in direction can also be greater than 45°.

The invention also relates to an optical plug connector for closing or for disconnecting an optical connection with at least one optical waveguide. The optical plug connector has a plug connector housing, which is preferably connectable to a counter plug connector housing of a counter plug connector via a catch connection or alternatively via a screw connection or a bayonet connection. The optical ferrule is preferably mounted floating in the plug connector housing of the optical plug connector, while the optical counter ferrule is mounted fixed in the counter plug connector housing of the optical counter plug connector. Alternatively, the optical ferrule and the optical counter ferrule can each be mounted floating in the plug connector housing of the optical plug connector or in the counter plug connector housing of the optical counter plug connector, respectively.

For the floating mounting of the optical ferrule in the optical plug connector, the optical ferrule is arranged on the plug side and a spring axially connected to the optical ferrule is arranged on the cable side in an axial feedthrough of the plug connector housing. The floating mounting of the optical ferrule in the lateral direction is implemented by a circumferential air gap between the optical ferrule and the inner wall of the feedthrough. The floating mounting of the optical ferrule in the axial direction is carried out in that the optical ferrule is pressed by the spring force of the spring mounted with pre-tension against a step of the feedthrough. In the plugged-together state of the optical ferrule and the optical counter ferrule, the optical ferrule detaches from the step. The increased spring force of the additionally pre-tensioned spring exerts a sufficient plug-in force on the plugged-together pair made up of the optical ferrule and the optical counter ferrule. In order that the spring can preferably introduce a force in the longitudinal axial direction (or in the plug-in direction) into the optical ferrule, an end face planar in the plug-in direction, as in a leaf spring, a spiral spring, or an elastomer element, for example, is formed on the spring.

In the feedthrough of the plug connector housing, a mechanical interface is formed on the plug side, which interacts with a mechanical counter interface of the optical counter plug connector, which is formed on the plug side in an axial feedthrough of the counter plug connector housing. The mechanical interface can preferably be formed pin-shaped and can be insertable into a socket-shaped mechanical counter interface. Alternatively, however, the mechanical interface can also be embodied as socket-shaped and the mechanical counter interface as pin-shaped.

On the cable side, a cable is inserted into the feedthrough of the plug connector housing of the optical plug connector and fixed via a clamping means on the plug connector housing. The cable contains the optical waveguides, which are connected to the optical ferrule. The clamping means can be integrally formed with the plug connector housing or can represent a separate component from the plug connector housing. The clamping can take place in a friction-locked, formfitting, or materially-bonded manner. Alternatively, the individual optical waveguides can also be led separately without a cable to the optical plug connector and fixed via an associated clamping means on the plug connector housing of the optical plug connector.

Such a design of an optical plug connector having a spring acting in the plug-in direction and an optical ferrule significantly simplifies the structure and the technical function of the optical plug connector. In a delimitation from conventional optical lens plug connectors, separate cable securing outside the optical plug connector, in particular cable securing formed and acting diagonally to the longitudinal axial direction, is not necessary. The spring force acting on the optical ferrule can be set more precisely with respect to its direction and its dimension by the design of the spring arranged inside the optical plug connector.

The above-mentioned technical features, technical effects, and technical advantages with respect to the optical ferrule also apply equivalently to the optical plug connector.

The invention finally also relates to an optical plug connection made up of an optical plug connector and an associated optical counter plug connector. The optical counter plug connector has an optical counter ferrule and a counter plug connector housing accommodating the optical counter ferrule, which is connectable to the plug connector housing of the optical plug connector. The optical ferrule and the optical counter ferrule are optically and mechanically coupled with one another in that the ribbed segment of the associated counter guide area of the optical counter ferrule is accommodated in the grooved segment of each guide area of the optical ferrule.

Such an optical plug connection is characterized by a simple mechanical guide mechanism and by a simple optical coupling between an optical ferrule and an optical counter ferrule. In this way, secure and precise plugging can be implemented between an optical plug connector and an associated optical counter plug connector with reduced optical losses.

The above-mentioned technical features, technical effects, and technical advantages with respect to the optical ferrule and optical plug connector also apply equivalently to the optical plug connection.

The designs and refinements above can be combined with one another as desired, if reasonable. Further possible designs, refinements, and implementations of the invention also comprise combinations, which are not explicitly mentioned, of features of the invention which are described above or hereinafter with respect to exemplary embodiments. In particular, a person skilled in the art will also add individual aspects as improvements or additions to the respective basic form of the present invention in this case.

### SUMMARY OF THE DRAWING

The present invention will be explained in more detail hereinafter on the basis of embodiments indicated in the schematic figures of the drawing. In the figures:

FIGS. 1A, 1B, 1C show an isometric view, a top view, and a side view of a first embodiment of an optical ferrule according to the invention,

FIGS. 1D, 1E, 1F show a top view, a side view, and a longitudinal sectional view of a first embodiment of optical ferrule and optical counter ferrule in the non-plugged-together state,

FIGS. 1G, 1H, 1I show a top view, a side view, and a longitudinal sectional view of a first embodiment of ferrule and optical counter ferrule in the plugged-together state,

FIGS. 1J, 1K show a first and a second cross-sectional view of a first embodiment of optical ferrule and optical counter ferrule in the plugged-together state,

FIGS. 1L, 1M show an isometric view of a first embodiment of optical ferrule and optical counter ferrule in the non-plugged-together and in the plugged-together state,

FIGS. 2A, 2B show an isometric view and a side view of a further embodiment of a centering for an optical ferrule according to the invention,

FIGS. 2C, 2D show a top view of optical ferrule and optical counter ferrule with a further embodiment of a centering in the non-plugged-together and in the plugged-together state,

FIGS. 3A, 3B, 3C show an isometric view, a top view, and a side view of a second embodiment of an optical ferrule according to the invention,

FIGS. 4A, 4B, 4C show an isometric view, a top view, and a side view of a third embodiment of an optical ferrule according to the invention, and

FIGS. 5A, 5B show a longitudinal sectional view of an optical plug connection with an optical ferrule according to the invention in the non-plugged-together and in the plugged-together state.

The appended figures of the drawing are to convey a further understanding of the embodiments of the invention. They illustrate embodiments and are used in conjunction with the description to explain principles and concepts of the invention. Other embodiments and many of the mentioned advantages result with regard to the drawings. The elements of the drawings are not necessarily shown in scale in relation to one another.

Identical, functionally-identical, and identically-acting elements, features, and components—if not indicated otherwise—are each provided with the same reference signs in the figures of the drawing.

The figures are described coherently and comprehensively hereinafter.

### DESCRIPTION OF EXEMPLARY EMBODIMENTS

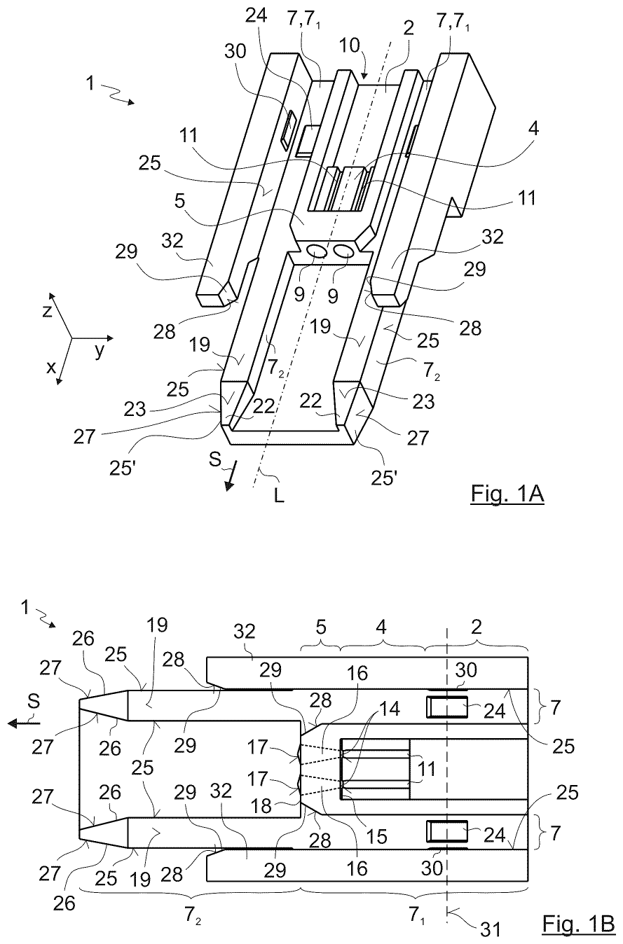

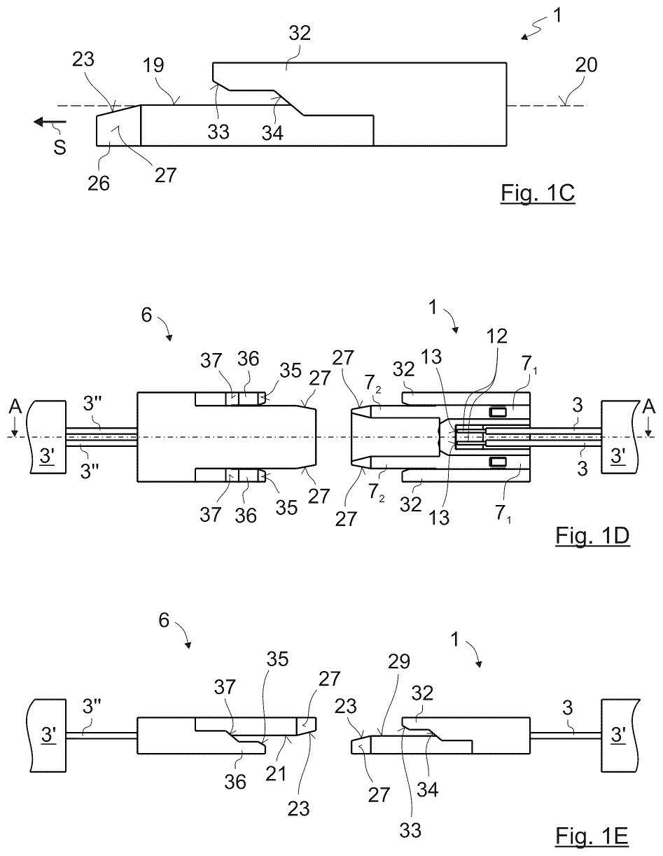

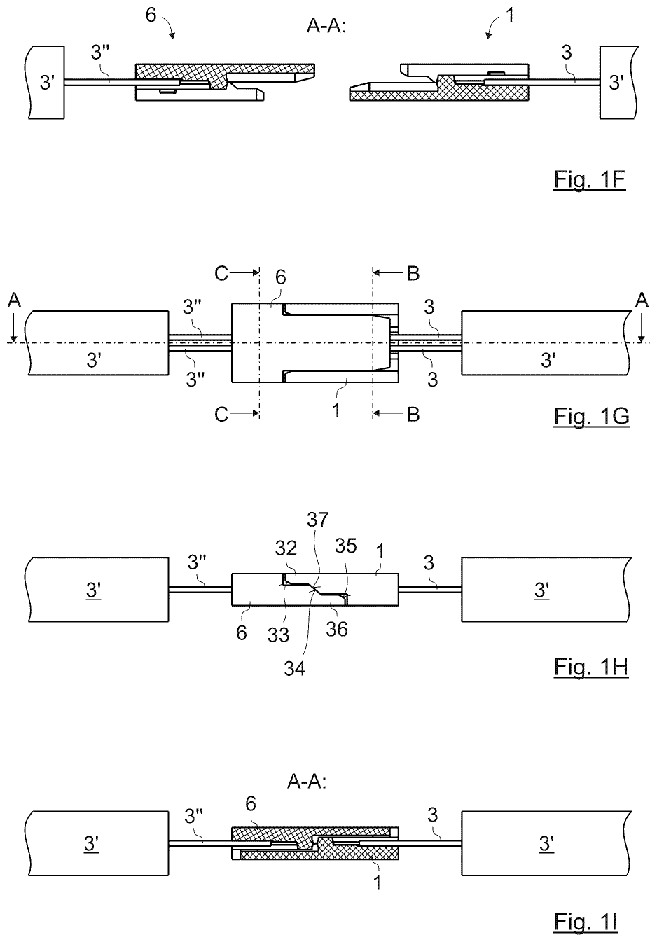

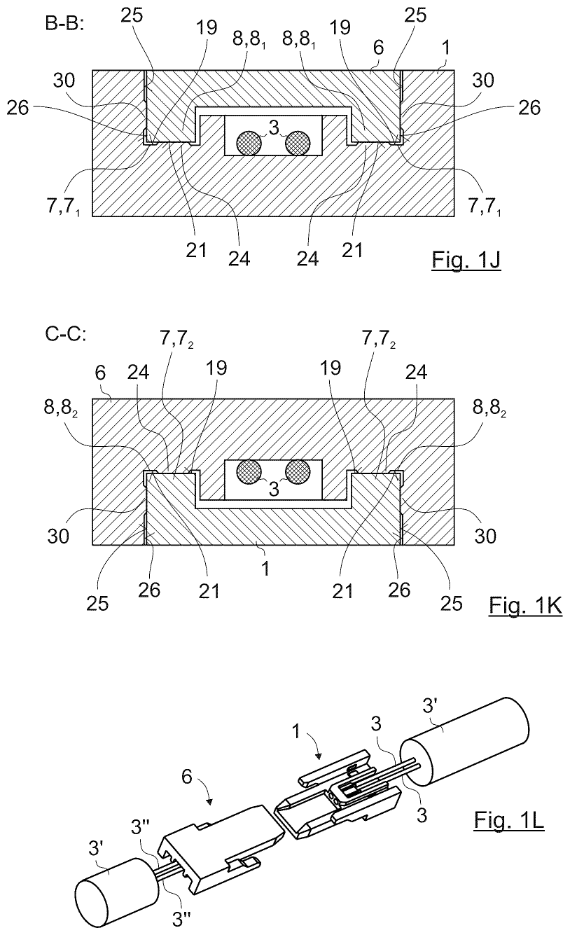

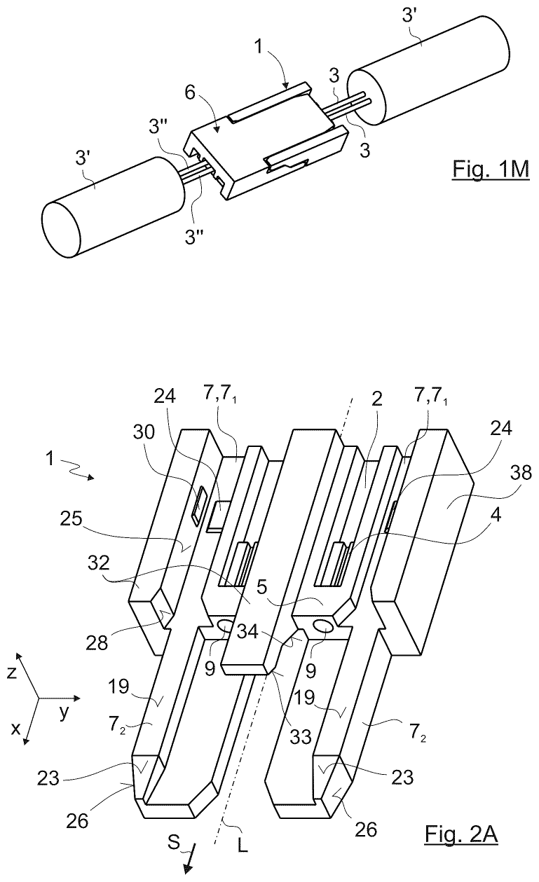

A first embodiment of an optical ferrule 1 according to the invention is shown in FIGS. 1A, 1B, and 1C, which represents a preferred embodiment of an optical ferrule 1. The interaction of a first embodiment of the optical ferrule 1 with an associated optical counter ferrule 6 can be inferred from FIGS. 1D, 1E, 1F, 1G, 1H, 1I, 1J, 1K, 1L, and 1M:

The optical ferrule 1 has, in the plug-in direction S, a receptacle area 2 for accommodating individual optical waveguides 3 in the optical ferrule 1, a fixing area 4 axially adjoining the receptacle area 2 for fixing the individual optical waveguides 3 on the optical ferrule 1, and an optical area 5 axially adjoining the fixing area 4 for beamforming of the light beam bundle to be coupled or decoupled into or out of the individual optical waveguides 3 (see in particular FIGS. 1B and 1D in this regard). The plug-in direction S of the optical ferrule 1 is directed in this case in the longitudinal axial direction x of the longitudinal axis L of the optical ferrule 1 (see in this regard the orientation of the plug-in direction S in the x-y-z coordinate system of FIG. 1A).

In a first embodiment of the optical ferrule 1, two guide areas 7 are formed for coupling the individual light beam bundles between the optical area 5 of the optical ferrule 1 and the optical area of an associated optical counter ferrule 6 in a direction x parallel to the longitudinal axis L of the optical ferrule 1. These two guide areas 7 are each embodied as a linear guide area and form a linear guide with an associated counter guide area 8 of an optical counter ferrule 6 (see in this regard FIGS. 1D to 1K).

On each side of the optical area 5, in particular laterally adjacent to the beamforming means 9 formed in each case in the optical area 5, one of the two guide areas 7 of the optical ferrule 1 is formed in each case in a first transverse direction ty, which is directed orthogonally to the direction x of the longitudinal axis L in each case. The individual guide area 7 is not only formed laterally adjacent to the optical area 5, but also laterally adjacent to the receptacle area 2 and to the fixing area 4. The individual guide area 7 is formed laterally adjacent to the feed-in area 2, to the fixing area 4, and to the optical area 5 in each case as a grooved segment 7₁, in which a ribbed segment 8₁ of an associated counter guide area 8 of an optical counter ferrule 6 is guided and therefore aligned (see in this regard the cross-sectional plane B-B in FIG. 1J). A ribbed segment 7₂ of the individual guide area 7, which is guided and therefore aligned in a grooved segment 8₂ of the individual counter guide area 8 (see in this regard the cross-sectional plane C-C in FIG. 1K) is adjoined in the plug-in direction S by the grooved segment 7₁ of the individual guide area 7.

The receptacle area 2 of the optical ferrule 1 has an end-face opening 10 for feeding the individual optical waveguides 3. A clamping means (not shown in the figures) is typically provided inside the receptacle area 2, and clamps the individual optical waveguide 3 on its outer shell with regard to axial and lateral preliminary fixing.

In the fixing area 4 axially adjoining the receptacle area 2, a groove 11 is formed for each optical waveguide 3, the longitudinal extension of which groove extends in the direction x of the longitudinal axis L of the optical ferrule 1. To align the individual optical waveguides 3 in the direction of the longitudinal axis L, each groove 11 preferably has a V-shaped cross-sectional profile. As can be seen from FIG. 1D, an axial end section 12 of the optical waveguide 3 is located inside the groove 11 of the fixing area 2. The axial end section 12 of the optical waveguide 3 is an inner core, exposed from the casing, from the protective coating, and from the outer shell, of the optical waveguide 3 formed as a glass fiber. As can also be seen from FIG. 1D, the fiber end face 13 of each optical waveguide 3 is located in each case in a position which corresponds to the axial end of the associated groove 11 in the plug-in direction S of the optical ferrule 1. The fiber end face 13 of the individual optical waveguide 3 therefore in each case directly contacts an optically active surface 14 of an associated beamforming means 9 at the input-side end 15 of the optical area 5. The individual optical waveguide 3 is preferably fixed in the associated groove 11 of the fixing area 4 by means of a transparent adhesive.

In the optical ferrule 1 shown in each of the figures, for example two grooves 11 are shown for fixing one optical waveguide 3 in each case. Alternatively, a higher number of grooves 11 for fixing a corresponding number of optical waveguides 3 is also scalable. The two optical waveguides 3 preferably each transmit an optical data signal in a different transmission direction. However, it is also conceivable that the two optical waveguides 3 each transmit an optical data signal in the same transmission direction.

A number of beamforming means 9 corresponding to the number of optically coupled optical waveguides 3 is formed in the optical area 5 of the optical ferrule 1. Each beamforming means 9 extends in a section 16 of the optical area 5, shown by dashed lines in each case in FIG. 1B, from an optically active surface 14, which is formed at an input-side end 15 of the optical area 5 in the plug-in direction S, up to an optically active surface 17, which is formed at an output-side end 18 of the optical area 5 in the plug-in direction S. The optically active surface 14 of each beamforming means 9 at the input-side end 15 of the optical area 5 is preferably formed planar or at most concave in each case. The optically active surface 17 of each beamforming means 9 at the output-side end 18 of the optical area 5 is formed convex in each case, in order to emit a focused or collimated light beam bundle into a free space in the direction of the optical area of the optical counter ferrule 6 or alternatively to focus a focused or collimated light beam bundle received from the optical area of the optical counter ferrule 6 in the free space in the associated optical waveguide 3.

Each guide area 7 of the optical ferrule 1 has a planar first guide surface 19, the surface vector of which is directed in a second transverse direction z, which is directed orthogonally to the longitudinal axial direction x of the longitudinal axis L (or to the plug-in direction S) and orthogonally to the first transverse direction y. The planar first guide surface 19 of each guide area 7 extends without a step over the grooved segment 7₁ and the ribbed segment 7₂ of the respective guide area 7. The planar first guide surface 19 of each guide area 7 of the optical ferrule 1, the optical axis of each beamforming means 9 in the optical area 5 of the optical ferrule 1, and/or the optical axis of the axial end sections 12 of each fixed optical waveguide 3 are located on a first sectional plane 20 of the optical ferrule 1 shown in FIG. 1C. In the plug-in procedure, the associated planar first counter guide surface 21 of the associated counter guide area 8 of the optical counter ferrule 6 slides along the planar first guide surface 19 of each guide area 7 of the optical ferrule 1.

A first centering surface 23 is formed as a chamfer in each case in a front end section 22 in the plug-in direction S of the planar first guide surfaces 19 of each guide area 7 of the optical ferrule 1. The first centering surface 23, formed as a chamfer, of each guide area 7 of the optical ferrule 1 cooperates with a first centering surface 23 in a front end section 22 of the planar first counter guide surface 21 of the associated counter guide area 8 of the optical counter ferrule 6 if the distance between the optical ferrule 1 and optical counter ferrule 6 in the second transverse direction z is excessively small. In this way, a rough alignment takes place between the optical ferrule 1 and optical counter ferrule 6 in the second transverse direction z.

For a fine alignment between the optical ferrule 1 and the optical counter ferrule 6 in the second transverse direction z, in each case a first centering support 24 protrudes out of the planar first guide surface 19 in the grooved segment 7₁ of each guide area 7. A corresponding area of the planar first counter guide surface 21 of the associated counter guide area 8 of the optical counter ferrule 6 rests on the first centering support 24 of each guide area 7 of the optical ferrule. Equivalently, in each case a first centering support 24 protrudes out of the grooved segment 8₂ of each counter guide area 8, on which a corresponding area of the planar first guide surface 19 of the associated guide area 7 of the optical ferrule 1 rests.

A planar second guide surface 25 is formed in each case in the grooved segment 7₁ and in the ribbed segment 7₂ of each guide area 7 of the optical ferrule 1. The planar second guide surface 25 of each guide area 7 is oriented orthogonally in each case to the planar first guide surface 19 of the associated guide area 7. In this case, this is preferably the outer planar second guide surface 25 of the individual guide areas 7 of the optical ferrule 1. In the plug-in procedure, the planar second counter guide surface 26 of the associated counter guide area 8 of the optical counter ferrule 6, which is preferably also formed on the exterior, slides along the planar second guide surface 25 of each guide area 7 of the optical ferrule 1.

A centering surface 27 is in each case formed as a chamfer, which is referred to in this case and hereinafter as the second centering surface 27, in a front end section 25′ in the plug-in direction S of the planar second guide surface 25 in the ribbed segment 7₂ of each guide area 7 of the optical ferrule 1. The second centering surface 27 in the ribbed segment 7₂ of each guide area 7 of the optical ferrule 1 cooperates with a centering surface 28, formed as a chamfer, in a front end section 29 in the plug-in direction S of a planar second counter guide surface 26 in the grooved segment 8₂ of each counter guide area 8 of the optical counter ferrule 6. This centering surface 28 is referred to in this case and hereinafter as the third centering surface 28.

In this way, rough centering takes place during the plug-in procedure between the optical ferrule 1 and the optical counter ferrule 6 in the first transverse direction ±y. The third centering surface 28 in the front end section 29 of a planar second counter guide surface 26 in the grooved segment 8₂ of a counter guide area 8 of the optical counter ferrule 6 corresponds to a third centering surface 28 in the front end section 29 of a planar second guide surface 25 in the grooved segment 7₁ of a guide area 7 of the optical ferrule 1.

As can be seen in particular from FIG. 1B, the grooved segment 7₁ and the ribbed segment 7₂ of each guide area 7 of the optical ferrule 1 can also have, alternatively or additionally to an outer planar second guide surface 25, an inner planar second guide surface 25. The inner planar second guide surface 25 can also have a second centering surface 27 in a front end section 25′ in the ribbed segment 7₂ and can have a third centering surface 28 in a front end section 29 in the grooved segment 7₁.

In the grooved segment 7₁ of each guide area 7 of the optical ferrule 1, a second centering support 30 protrudes in each case out of the planar second guide surface 25, on which an area of the planar second counter guide surface 26 of the associated counter guide area 8 of the optical counter ferrule 6 rests with regard to fine centering between the optical ferrule 1 and the optical counter ferrule 6 in the first transverse direction ±y. Equivalently, a second centering support 30, on which an area of the planar second guide surface 25 of the associated guide area 7 of the optical ferrule 1 rests, in each case protrudes out of the planar second counter guide surface 26 in the grooved segment 8. of each counter guide area 8 of the optical counter ferrule 6. As can be seen from FIG. 1B, all first centering supports 24 and all second centering supports 30 can be arranged on the same axial position within the optical ferrule 1, in particular on the second sectional plane 31 of the optical ferrule 1, shown by dashed lines.

In addition, in the first embodiment of the optical ferrule 1, a centering means 32 can be formed in each case laterally adjacent to the two guide areas 7. A side wall of each centering means 32 forms an outer planar second guide surface 25 of the adjacent guide area 7 in each case. A fourth centering surface 33 and a fifth centering surface 34, each of which has a first directional component in the plug-in direction S and a second directional component in a direction opposite to a surface vector of the planar first guide surface 19, are formed on each centering means 32. Within the centering means 32, the fourth centering surface 33 is formed axially upstream from the fifth centering surface 34 in the plug-in direction S.

With a greater distance between the optical ferrule 1 and the optical counter ferrule 6 in the second transverse direction z, in the plug-in procedure, first the fourth centering surfaces 33 of the two centering means 32 of the optical ferrule 1 meet one another on the fourth counter centering surfaces 35 of associated counter centering means 36 of the optical counter ferrule 6 and cause rough centering between the optical ferrule 1 and the optical counter ferrule 6 in the second transverse direction z. Fine centering between the optical ferrule 1 and the optical counter ferrule 6 in the second transverse direction z thereupon takes place due to meeting of the fifth centering surfaces 34 of the two centering means 32 of the optical ferrule 1 with the fifth counter centering surfaces 37 of the associated counter centering means 36 of the optical counter ferrule 6. Reference is made in this case to FIGS. 1C, 1E, and 1H on the design of the centering means 32 and the associated counter centering means 36. The fifth centering surfaces 34 of the optical ferrule 1 and the fifth counter centering surfaces 37 of the optical counter ferrule 6 additionally form a stop function between the optical ferrule 1 and the optical counter ferrule 6 in the longitudinal axial direction x (or plug-in direction S). The fourth centering surfaces 33 and the fifth centering surfaces 34 of the optical ferrule 1 as well as the fourth counter centering surfaces 35 and the fifth counter centering surfaces 37 of the optical counter ferrule 6 cause the optical ferrule 1 and the optical counter ferrule 6 to move together in the second transverse direction z.

The non-plugged-together state between the optical ferrule 1 and the optical counter ferrule 2 can be seen in a top view in FIG. 1D, in a side view in FIG. 1E, and in a longitudinal sectional view in FIG. 1F. The longitudinal sectional view of FIG. 1F results in this case from a section along the longitudinal axis L of the optical ferrule 1 or the optical counter ferrule 6. The plugged-together state between the optical ferrule 1 and the optical counter ferrule 2 can be seen in a top view in FIG. 1G, in a side view in FIG. 1H, and in a longitudinal sectional view in FIG. 1I. In this case, the individual optical waveguides 3 of the optical ferrule 1 and the counter optical waveguides 3″ of the optical counter ferrule 6 are each brought together outside the optical ferrule 1 or the optical counter ferrule 6 in a common cable 3′.

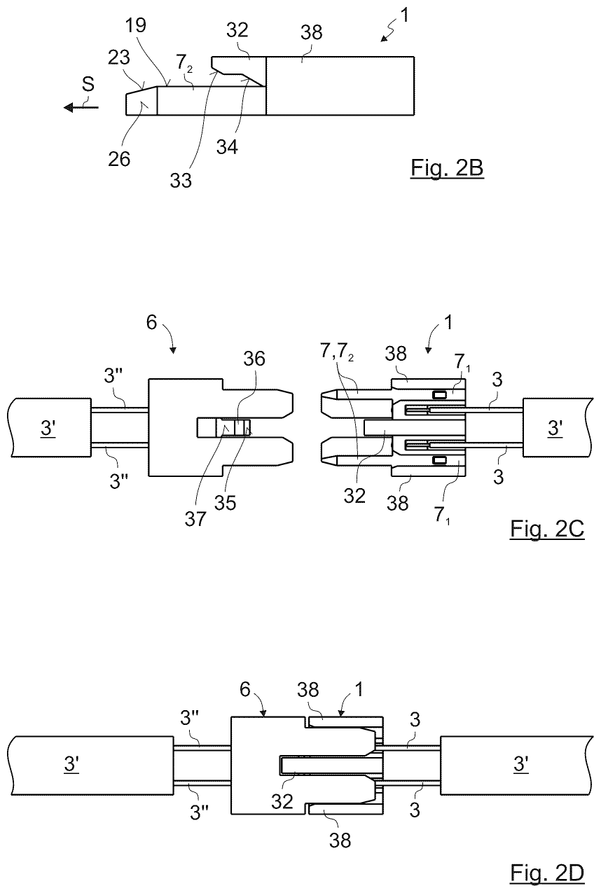

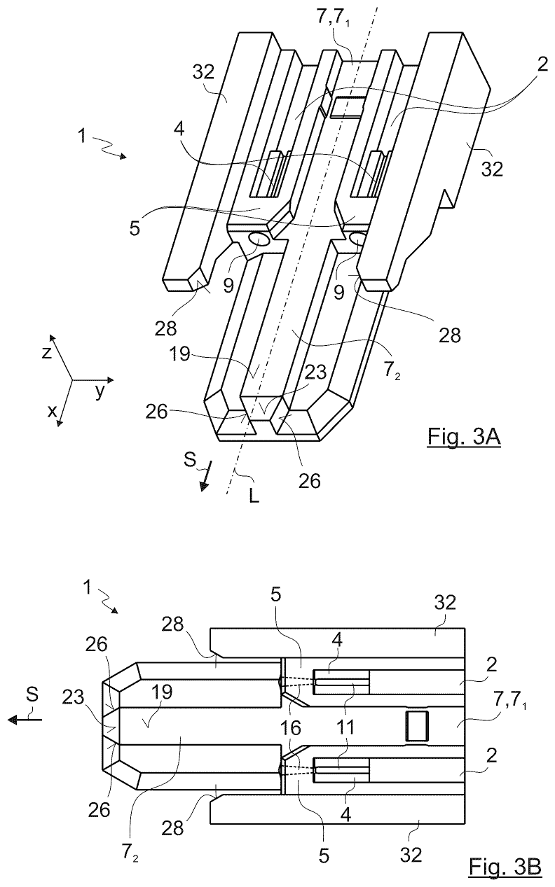

A further embodiment of a centering in an optical ferrule 1 according to the invention can be seen in FIGS. 2A and 2B. The interaction of an optical ferrule 1 according to the invention with an associated counter optical ferrule 6 with the further embodiment of the centering is shown in FIGS. 2C and 2D:

In the further embodiment of a centering, a single centering means 32 is formed having a fourth centering surface 33 and a fifth centering surface 34. The single centering means 32 is formed centrally inside the optical ferrule 1 along the longitudinal axis L and divides the receptacle area 2, the fixing area 4, and the optical area 5 into two sections in each case, which are each formed laterally adjacent to the centering means 32. The fourth centering surface 33 and the fifth centering surface 34 of the single centering means 32 of the optical ferrule 1 interacts with a fourth counter centering surface 35 or a fifth counter centering surface 37 of the single counter centering means 36 of the optical counter ferrule 6. The single counter centering means 36 of the optical counter ferrule 6 is also formed centrally inside the optical counter ferrule 6 along the longitudinal axis L.

To form a grooved segment 71 for the two guide areas 7 of the optical ferrule 1, a wall section 38, which forms a planar second guide surface 25 on the inside, is formed laterally adjacent to each of the two guide areas 7.

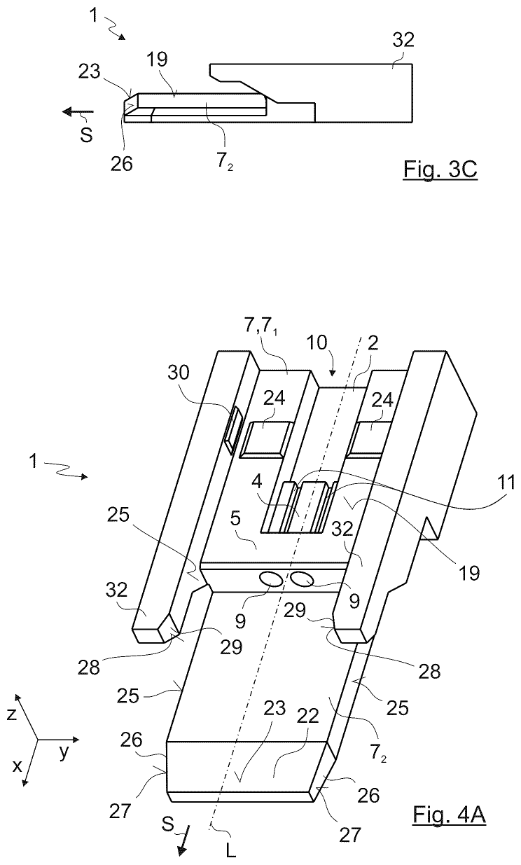

A second embodiment of an optical ferrule 1 according to the invention is shown in FIGS. 3A, 3B, and 3C:

In the second embodiment of an optical ferrule 1 according to the invention, a single guide area 7 is provided, which is formed centrally inside the optical ferrule 1 along the longitudinal axis L. The single guide area 7 of the optical ferrule 1 forms a linear guide with a single counter guide area 8 of the optical counter ferrule 6, which is also formed centrally inside the optical counter ferrule 6 along the longitudinal axis L.

The single guide area 7 divides the receptacle area 2, the fixing area 4, and the optical area 5 in each case into two sections, each of which is directly adjoined by a centering means 32.

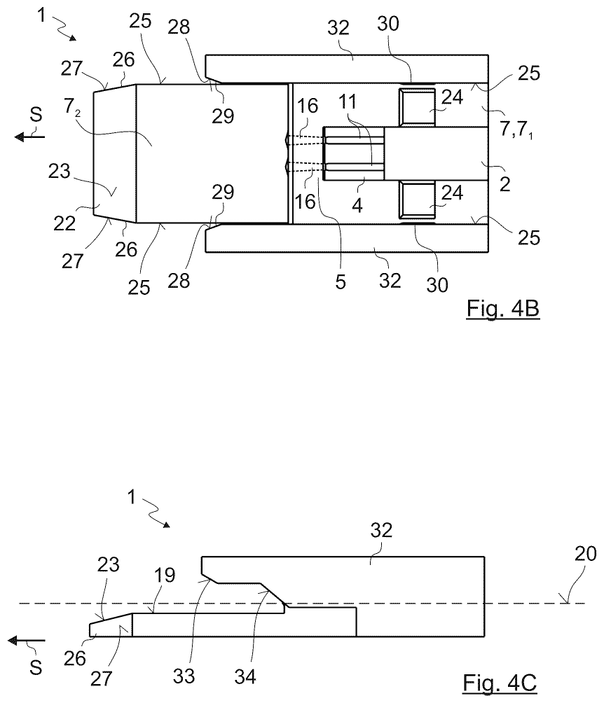

A third embodiment of an optical ferrule 1 according to the invention is shown in FIGS. 4A, 4B, and 4C:

In the third embodiment of an optical ferrule 1 according to the invention, a single guide area 7 is formed symmetrically to the longitudinal axis L, which forms a linear guide with a single counter guide area 8 of the counter ferrule 6, also formed symmetrically to the longitudinal axis L. The grooved segment 7₁ of the single guide area 7 is formed laterally to the optical area 5, to the fixing area 4, and to the receptacle area 2 in the second transverse direction z and is framed by the two laterally formed centering means 32. A ribbed segment 8₁ of the single counter guide area 8 of the optical counter ferrule 6 is aligned and accommodated in the grooved segment 7₁ of the single guide area 7 of the optical ferrule 1.

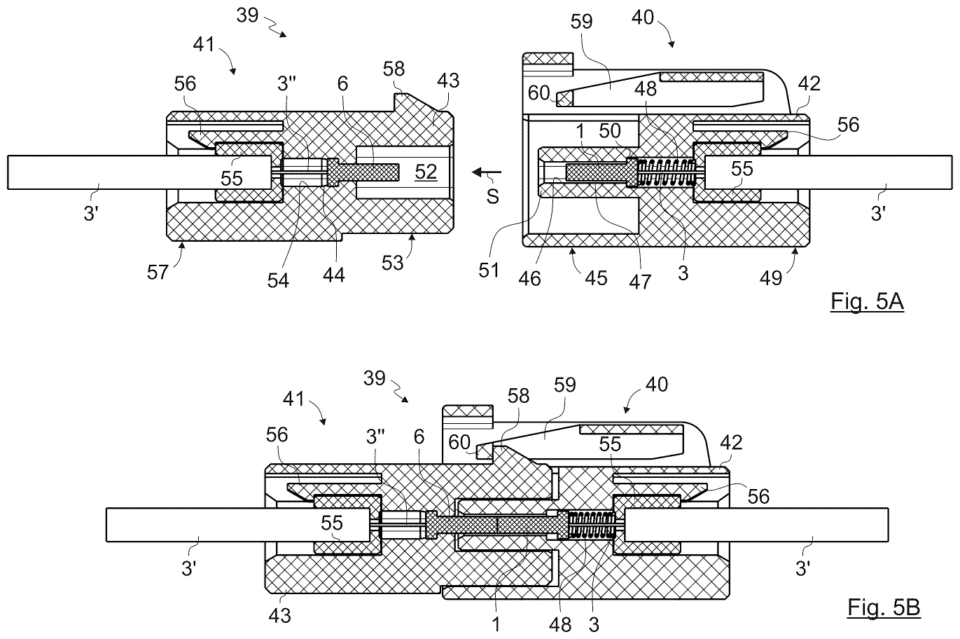

An optical plug connection 39 having an optical plug connector 40 and an associated optical counter plug connector 41 is shown in the non-plugged-together state and in the plugged-together state in FIGS. 5A and 5B, respectively:

The optical ferrule 1, which is arranged in a plug connector housing 42 of the optical plug connector 40, and the optical counter ferrule 6, which is arranged in a counter plug connector housing 43 of the optical counter plug connector 41, are each only schematically shown as cuboid bodies in FIGS. 5A and 5B to simplify the illustration. The optical ferrule 1 is mounted floating in the plug connector housing 42 of the optical plug connector 40, while the optical counter ferrule 6 is mounted fixed, for example, in the counter plug connector housing 43 (see the fixing hooks 44 of the counter plug connector housing 43 for this purpose). Alternatively, it is also possible that both the optical ferrule 1 and the optical counter ferrule 6 are mounted floating.

The optical ferrule 1 is mounted floating in a plug-side end area 45 of a feedthrough 46 formed in the axial direction in the plug connector housing 42. The floating mounting of the optical ferrule 1 in the lateral direction is implemented by an air gap 47, which is formed circumferentially between the optical ferrule 1 and the inner wall of the feedthrough 46. The floating mounting in the axial direction takes place in that the optical ferrule 1 is subjected in the plug-in direction S of the optical plug connector 40 to the spring force of a spring 48 mounted pre-tensioned in the feedthrough 46, which directly axially adjoins the optical ferrule 1 in the direction of a cable-side end area 49 of the feedthrough 46. In the non-plugged-together state of the optical plug connection 39 according to FIG. 5A, the optical ferrule is elastically pressed by the spring 48 against a step 50 formed in the feedthrough 46. In the plugged-together state of the optical plug connection 39 according to FIG. 5B, the optical ferrule 1 detaches from the step 50 in the direction of the cable-side end 49 of the feedthrough 46. The spring 48, which is thus additionally compressed, causes sufficient axial fixing between the optical ferrule 1 and the optical counter ferrule 6 with its increased spring force.

To implement a plug-in procedure between the optical ferrule 1 and the optical counter ferrule 6, a mechanical interface 51 is formed on the plug side in the plug connector housing 42 of the optical plug connector 40, which interface interacts with a mechanical counter interface 52 on the plug-side end 53 of the counter plug connector housing 43 of the optical counter plug connector 41. The mechanical interface 51 of the optical plug connector 40 is formed pin-shaped, for example, and can be inserted and accommodated in a socket-shaped mechanical counter interface 52 of the optical counter plug connector 41. Alternatively, the mechanical interface 51 of the optical plug connector 40 can also be formed socket-shaped and can be able to be inserted and accommodated in a mechanical counter interface 52 of the optical counter plug connector 41, which can be formed pin-shaped.

The socket-shaped mechanical counter interface 52 of the counter plug connector housing 43 forms the plug-side end section of a feedthrough 54 formed axially in the counter plug connector housing 43. The optical counter ferrule 6 is mounted fixed in the feedthrough 54 of the counter plug connector housing 43 and protrudes far enough into the socket-shaped mechanical counter interface 52 that in the plugged-together state, the optical counter ferrule 6 protrudes into the feedthrough 46 of the plug connector housing 42 and is pluggable with the optical ferrule 1 mounted floating therein.

For this purpose, the optical ferrule 1 is arranged set back inside the feedthrough 46 in the area of the pin-shaped mechanical interface 51 of the plug connector housing 42.

At the cable-side end 49 of the feedthrough 46 of the optical plug connector 40, the feedthrough 46 is expanded in order to accommodate a cable 3′ having the optical waveguides 3. The cable 3′ is fixed via a cable fixing means 55 on the plug connector housing 42. The fixing of the cable 3′ on the cable fixing means 55 can be implemented in a friction-locked (for example, by means of compression), formfitting (for example, by means of a catch), or materially-bonded (for example, by means of an adhesive bond) manner. The cable fixing means 55 can be embodied integrally with the plug connector housing 42 or as a part separate from the plug connector housing 42, as shown in FIGS. 5A and 5B. In the latter case, the cable fixing means 55 can be fixed, for example in a formfitting manner on the plug connector housing 42 via a catch hook 56 formed on the plug connector housing 42.

In the cable-side end area 57 of the axial feedthrough 54 of the counter plug connector housing 43, a cable 3′ having the optical waveguides 3 accommodated and fixed in the optical counter ferrule 6 is fixed on the counter plug connector housing 43 in an equivalent manner to the cable fixing in the plug connector housing 42 via a cable fixing means 52. The plug connector housing 42 of the optical plug connector 40 and the counter plug connector housing 43 of the optical counter plug connector 41 are fixed in relation to one another in a typical manner via a catch connection by means of a catch hook 58 and a catch recess 59 in an elastically embodied catch tab 60.

Although the present invention was completely described above on the basis of preferred exemplary embodiments, it is not restricted thereto, but rather can be modified in a variety of ways.

1. An optical ferrule for aligning an optical waveguide with a counter optical waveguide of an optical counter ferrule, the optical ferrule comprising:
a fixing portion for fixing an axial end section of the optical waveguide, wherein the fixing portion is designed such that a longitudinal axis of the axial end section of the optical waveguide is alignable in a plug-in direction S of the optical ferrule,
an optical portion, for beamforming between a light beam bundle transmitted in the optical waveguide and a light beam bundle transmitted in a focused or collimated manner in a free space, which axially adjoins the fixing portion in the plug-in direction S, the optical portion comprising a beamforming means having an optical axis extending in the plug-in direction S, and
at least one guide portion having a longitudinal extension in the plug-in direction S,
wherein each of the at least one guide portion includes at least one grooved segment,
wherein each groove segment of the at least one grooved segment is formed laterally adjacent to the beamforming means and is configured to align itself with a corresponding ribbed segment of an associated counter guide portion of the optical counter ferrule.

2. The optical ferrule of claim 1,
wherein each of the at least one guide portion additionally comprises an at least one ribbed segment that axially adjoins a corresponding grooved segment of the at least one grooved segment of the guide portion in the plug-in direction S, wherein the ribbed segment is configured to align itself with a corresponding grooved segment of the associated counter guide portion of the counter ferrule.

3. The optical ferrule of claim 2,
wherein, in each of the at least one guide portion, each of the grooved segment of the at least one grooved segment and each of the ribbed segment of the at least one ribbed segment has a planar first guide surface, which lies either in a first sectional plane of the optical ferrule or parallel to the first sectional plane of the optical ferrule.

4. The optical ferrule of claim 3,
wherein the first sectional plane is either spanned by the optical axes of the beamforming means or is formed by a plane of symmetry of the optical axes of the beamforming means.

5. The optical ferrule of claim 3,
wherein a first centering surface is formed in an end section, which is in front in the plug-in direction S, of the planar first guide surface of each ribbed segment of the at least one ribbed segment.

6. The optical ferrule of claim 3,
wherein a first centering support for fine alignment between the ferrule and the counter ferrule protrudes out of the planar first guide surface in each grooved segment of the at least one grooved segment of each of the at least one guide portion.

7. The optical ferrule of claim 2,
wherein, in each of the at least one guide portion, each grooved segment of the at least one grooved segment and each ribbed segment of the at least one ribbed segment has a planar second guide surface oriented orthogonally to an associated planar first guide surface.

8. The optical ferrule of claim 7,
wherein, in each of the at least one guide portion, a second centering surface is formed in an end section, which is in front in the plug-in direction S, of the planar second guide surface of each ribbed segment of the at least one ribbed segment.

9. The optical ferrule of claim 7
wherein, in each of the at least one guide portion, a third centering surface is formed in an end section, which is in front in the plug-in direction, of the planar second guide surface of each grooved segment of the at least one grooved segment.

10. The optical ferrule of claim 7,
wherein a second centering support for fine alignment between the optical ferrule and the optical counter ferrule protrudes out of the planar second guide surface of each grooved segment of the at least one grooved segment of each of the at least one guide portion.

11. The optical ferrule of claim 10,
wherein each first centering support and its associated second centering support lie on a second sectional plane of the optical ferrule.

12. The optical ferrule of claim 3,
wherein at least one centering means having at least one further centering surface, which has a first directional component in the plug-in direction S and a second directional component in a direction opposite to a surface vector of the planar first guide surface, is formed in the optical ferrule laterally to the beamforming means and to each guide portion.

13. The optical ferrule of claim 12,
wherein the at least one further centering surface includes a fourth centering surface and a fifth centering surface,
wherein the fourth centering surface is configured for rough centering of the optical ferrule and the optical counter ferrule in a second transverse direction z,
wherein the fourth centering surface is axially upstream in the plug-in direction S from the fifth centering surface, and wherein the fifth centering surface is configured for fine centering of the optical ferrule and the optical counter ferrule in the second transverse direction z.

14. An optical plug connector comprising:
an optical ferrule including
(a) a fixing portion for fixing an axial end section of an optical waveguide, wherein the fixing portion is designed such that a longitudinal axis of the axial end section of the optical waveguide is alignable in a plug-in direction S of the optical ferrule,
(b) an optical portion, for beamforming between a light beam bundle transmitted in the optical waveguide and a light beam bundle transmitted in a focused or collimated manner in a free space, which axially adjoins the fixing portion in the plug-in direction S, the optical portion comprising a beamforming means having an optical axis extending in the plug-in direction S, and
(c) at least one guide portion having a longitudinal extension in the plug-in direction S, wherein each of the at least one guide portion includes at least one grooved segment, wherein each groove segment of the at least one grooved segment is formed laterally adjacent to the beamforming means and is configured to align itself with a corresponding ribbed segment of an associated counter guide portion of an optical counter ferrule;
a spring; and
a plug connector housing accommodating the optical ferrule and the spring,
wherein the spring is arranged between the plug connector housing and the optical ferrule in the plug-in direction S such that the spring is pre-tensioned, and
wherein the optical ferrule is arranged so that it is elastically movable in the plug-in direction S in the plug connector housing by a spring force of the pre-tensioned spring.

15. An optical plug connection comprising:
an optical plug connector and an associated optical counter plug connector,
wherein the optical plug connector comprises
i) an optical ferrule including:
(a) a fixing portion for fixing an axial end section of the optical waveguide, wherein the fixing portion is designed such that a longitudinal axis of the axial end section of the optical waveguide is alignable in a plug-in direction S of the optical ferrule,
(b) an optical portion, for beamforming between a light beam bundle transmitted in the optical waveguide and a light beam bundle transmitted in a focused or collimated manner in a free space, which axially adjoins the fixing portion in the plug-in direction S, the optical portion comprising a beamforming means having an optical axis extending in the plug-in direction S, and
(c) at least one guide portion having a longitudinal extension in the plug-in direction S, wherein each of the at least one guide portion includes at least one grooved segment, wherein each groove segment of the at least one grooved segment is formed laterally adjacent to the beamforming means and is configured to align itself with a corresponding ribbed segment of an associated counter guide portion of an optical counter ferrule;
(ii) a spring; and
(iii) a plug connector housing accommodating the optical ferrule and the spring, wherein the spring is arranged between the plug connector housing and the optical ferrule in the plug-in direction S such that the spring is pre-tensioned, and wherein the optical ferrule is arranged so that it is elastically movable in the plug-in direction S in the plug connector housing by a spring force of the pre-tensioned spring; and
wherein the optical counter plug connector comprises (a) the optical counter ferrule and (b) a counter plug connector housing accommodating the optical counter ferrule and connectable to the plug connector housing,
wherein the optical ferrule and the optical counter ferrule are opto-mechanically coupled with one another such that, in each guide portion of the optical ferule, each grooved segment of the at least one grooved segment accommodates a corresponding ribbed segment of the associated counter guide portion of the optical counter ferrule.

16. The optical ferrule of claim 1, wherein the beamforming means is a converging lens.

17. The optical ferrule of claim 3, wherein, in each of the at least one guide portion, each grooved segment of the at least one grooved segment and each ribbed segment of the at least one ribbed segment has a planar second guide surface oriented orthogonally to an associated planar first guide surface.

18. The optical ferrule of claim 5, wherein the first centering surface is a chamfer.

19. The optical ferrule of claim 8, wherein the second centering surface is a chamfer.

20. The optical ferrule of claim 9, wherein the third centering surface is a chamfer.
